(19) United States
(12) Patent Application Publication
(10) Pub. No.: US 2011/0000828 A1
(43) Pub. Date: Jan. 6, 2011

(54) SCREENING MACHINE WITH SEGMENTED SCREEN PANELS

(75) Inventors: Craig Richard Dressler, Ludlow, KY (US); E. Stephens Paxton, Wyoming, OH (US); Jeffrey D. Pielage, Cincinnati, OH (US); Brady P. Ballman, Loveland, OH (US); James Potter, Harrison, OH (US)

Correspondence Address: WOOD, HERRON & EVANS, LLP, 2700 CAREW TOWER, 441 VINE STREET, CINCINNATI, OH, 45202, US

(73) Assignee: ROTEX GLOBAL, LLC, Cincinnati, OH (US)

(21) Appl. No.: 12/883,422

(22) Filed: Sep. 16, 2010

Related U.S. Application Data
(63) Continuation-in-part of application No. 12/261,117, filed on Oct. 30, 2008.

(51) Int. Cl. B07B 1/46

(52) U.S. Cl. 209/405

(57) ABSTRACT

A screen panel assembly is used with a screening machine. The screen panel assembly includes first and second generally planar screen panels and a coupling between the first and second screen panels that includes latching mechanisms to temporarily secure the screen panels together. An overlap region between the first and second screen panels permits lifting of the second screen panel by a lifting force exerted upon the first screen panel while inhibiting the passage of material being screened between the two adjacent screen panels.

This is a continuation in part of U.S. patent application Ser. No. 12/261,117, filed Oct. 30, 2008 and hereby incorporated by reference in its entirety.

### BACKGROUND OF THE INVENTION

This invention relates to screening machines or separators of the type used to separate or classify mixtures of solid particles of different sizes.

In screening machines or separators of the type described, a screen (which may be woven, an aperture plate or another design) is mounted and pre-tensioned in what is often called a “screen pane” or “screen deck” that includes a supporting peripheral frame around the perimeter of the screen. The terms “screening machine” and “separator” and respective derivatives thereof are herein used interchangeably. A main housing of the screening machine supports one more of the screen panels, as well as agitating structures that shake or vibrate the solids deposited on the screen panels.

The screen panels are often removed from the screening machines for cleaning, replacement, readjustment or installation of a screen of a different mesh size or the like. In large commercial screening machines, the screen panels are inserted through and removed from a longitudinal end of the machine. In accordance with this movement of the screen panels, sufficient space must be devoted near the end of the machine, such that the generally horizontal screen panels may be inserted into and removed from the housing of the screening machine. Moreover, screen panels in large commercial screening machines tend to be relatively large, making their insertion and removal difficult or awkward at best, especially for a sole operator in tight working conditions.

Many machines of this type are used to separate particulate material which, over time, often clogs or blocks the screen mesh. Commonly, an agitating mechanism is included in the machine to unblock the mesh by dislodging the clogging material. Often, the agitating mechanism is a number of balls captured by a ball tray and accessible to the screen mesh. In large commercial screening machines, the agitating structures may be also inserted and removed respectively through the end of the machine, as described above with respect to the screen panels, thereby presenting similar space requirements. Moreover, known agitating structures tend to be large and relatively heavy, making their insertion into and removal from the housing of the screening machine a particularly difficult and work-intensive task for the operators involved.

It is evident, therefore, that a screening machine and screening machine components are needed that address these and other known problems associated with conventional screening machines.

### SUMMARY OF THE INVENTION

These and other shortcomings in the prior art have been addressed in various embodiments of this invention. In a first embodiment, a screen assembly is provided for use with a screening machine. The screen assembly includes first and second generally planar screen panels and a coupling between the first and second screen panels that includes a pair of latches on opposite side edges of the screen panels. The coupling may include an overlap region between the first and second screen panels that is engageable to thereby permit lifting of the second screen panel by a lifting force exerted upon the first screen panel. The first and second screen panels may be juxtaposed to one another along respective confronting end portions thereof, and a seal member is disposed between the end portions. The seal member may be positioned between a contoured feature on a top face of one of the screen panels and end edge of the other screen panel. The first and second screen panels may each include pre-tensioned screens mounted within a frame of the screen panel. The first and second screen panels may be substantially identical and interchangeable with one another.

In yet another embodiment, a screening machine includes a main housing and a screen panel assembly. The screen panel assembly has first and second generally planar screen panels and a coupling between the screen panels that is configured to permit movement of the first and second screen panels by a force that is exerted upon the first screen panel. The coupling in one embodiment includes a pair of latches on opposite side edges of the screen panels. The screening machine also includes an agitating structure that is supported by the main housing and which is configured to hold a plurality of agitating elements from moving material that is held by the screen panel assembly.

The agitating structure may include a stopping element for restricting movement of the screen panel assembly relative to the agitating structure. At least one of the first and second screen panels may include a limiting tab that is engageable with the stopping element for selectively restricting movement of the first and second screen panels relative to the agitating structure. The agitating elements may include balls.

In another embodiment, a method is provided for moving screening components relative to a main housing of a screening machine. The method includes applying a force on a first of two generally planar screen panels, with such force moving the two screen panels relative to the main housing. A seal is positioned relative to overlapping portions of the two screen panels, and the first screen panel is moved relative to the other screen panel.

In embodiments having a screen panel assembly that is made up of two or more generally planar screen panels, insertion and removal of the screen panel assembly respectively into and out of the main housing of the screening machine is greatly facilitated. Similarly, in embodiments having an agitating structure that includes segmented co-planar trays, insertion and removal of the agitating structure in conjunction with the screen panels is likewise facilitated.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a partially broken-away perspective view of a screen panel assembly being inserted into a screening machine in accordance with one embodiment of this invention;

FIG. 2 is a perspective view of a pair of screen panels according to one embodiment of this invention;

FIG. 3 is an enlarged partially broken-away view of the screen panels of FIG. 2 taken along line 3-3 of FIG. 2;

FIG. 4 is an enlarged partially broken-away view of the screen panels of FIG. 2 taken along line 4-4 of FIG. 2;

FIG. 5 is an enlarged partially broken-away view of the screen panels of FIG. 2 taken along line 5-5 of FIG. 2;

FIG. 6 is an enlarged partially broken-away view of the screen panels of FIG. 2 taken along line 6-6 of FIG. 2;

FIG. 7 is an enlarged partially broken-away perspective view of the latching mechanism joining adjacent screen panels of one embodiment of this invention; and

FIGS. 8A-8B are enlarged perspective sequential views of the interaction between the screen panels and ball tray of one embodiment of this invention.

### DETAILED DESCRIPTION OF THE INVENTION

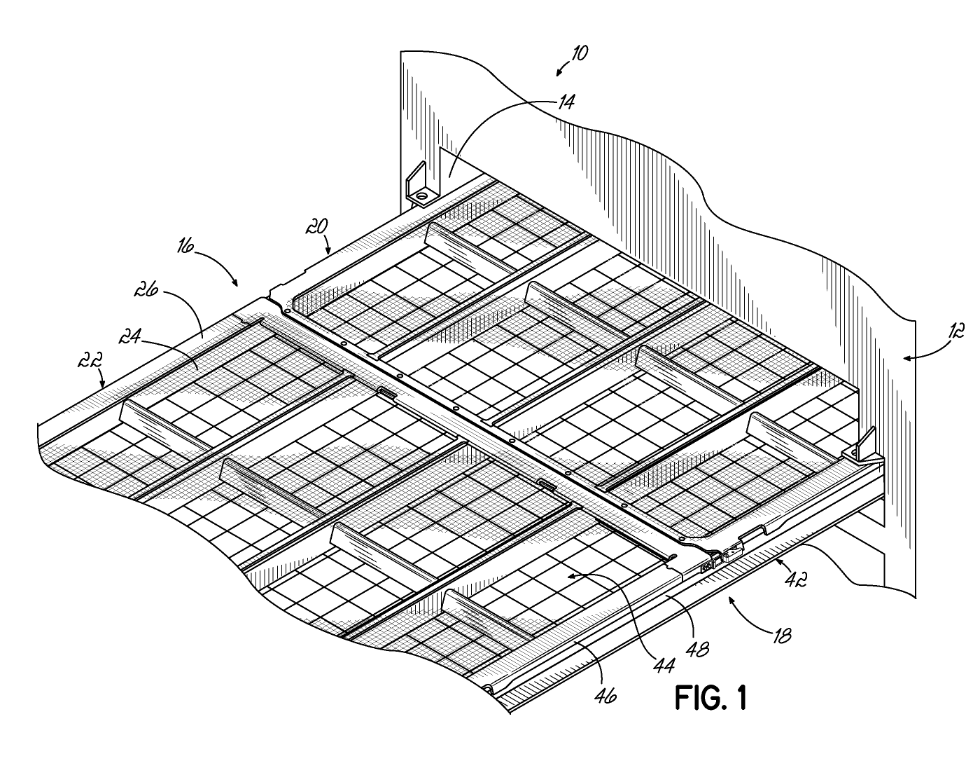

With reference to the figures, and more particularly to FIG. 1, a screening machine or separator 10 includes a main housing 12 having an access opening 14 located at a longitudinal end of the housing 12 for inserting and removing screening components such as a screen panel assembly 16 and an agitating structure 18 cooperating with the screen panel assembly 16 to segregate solids or other material (not shown) deposited on the screen panel assembly 16.

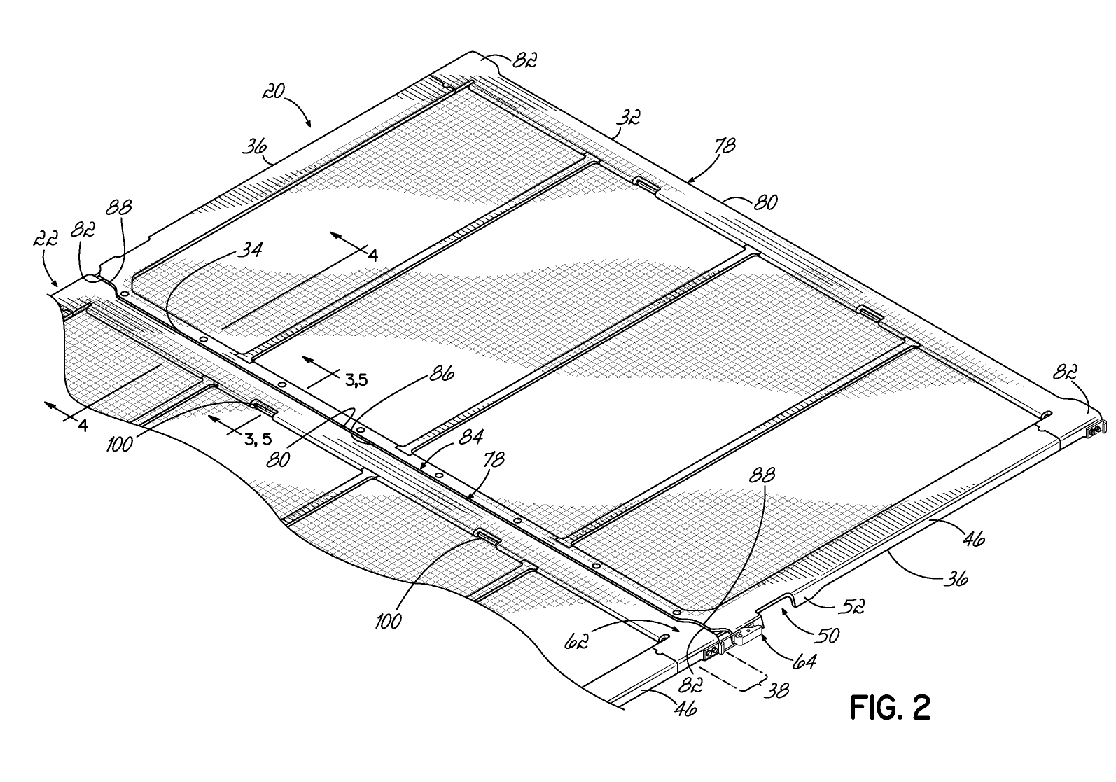

With reference to FIGS. 1-2, the screen panel assembly 16 of this exemplary embodiment is in the form of a segmented assembly that includes a first, leading screen panel 20 and a second, trailing screen panel 22 that are substantially identical to and interchangeable with one another. It is contemplated that the screen panel assembly 16 may instead have any number of screen panels other than two including, without limitation, a single screen panel, and still fall within the scope of this invention. Each of the screen panels 20, 22 includes a pre-tensioned screen 24 supported about the respective perimeters of the screens by a frame 26 and further includes a top face 28 and an opposite bottom face 30. The screen panels 20, 22 each have spaced longitudinal leading and trailing ends 32, 34 and spaced lateral sides 36 and are engageable with one another along adjacent ends to define an overlap a region 38. The screen panels 20, 22 are generally symmetric about a longitudinal center line.

The screen mesh material is pre-tensioned and mounted between the screen frame according to one embodiment of the screen panel according to this invention and secured to the frame via a cured or baked on enamel around the perimeter of the screen surface of the screen panel. Alternatively, epoxies or other materials may be utilized to secure the pre-tensioned screen material to the frame.

The overlap region 38 includes a seal member 40 mounted to one of the screen panels and prevents or at least minimizes the likelihood of material deposited on the screen panels 20, 22 from falling onto the underlying agitating structure 18.

In this exemplary embodiment, the agitating structure 18 is in the form of a segmented tray assembly having multiple, generally coplanar trays 42 that are also engageable with one another through a tray coupling (not shown). Additional details of one embodiment of the agitating structure 16 are detailed in co-pending patent application Ser. No. 12/261,117. Each of the trays 42 in this exemplary embodiment is partitioned into several compartments 44 (FIG. 1). Longitudinal by extending lips 46 of each of the screen panels 20, 22 engage respective side walls 48 of the trays 42 and thereby determine a position of the screen panels 20, 22 relative to the trays 42 when these components are engaged with one another within the main housing 12 (FIG. 1). Each of the longitudinal lips 46 extends only partially along the respective length of the associated screen panel 20, 22 to define a notch 50 between each of the lips 46 and a stopping element in the form of a limiting tab 52. Each tray 42 also includes a flange 54 projecting vertically adjacent the lips of the screen panels and a longitudinal, generally horizontal projection 56.

It is contemplated, however, that an alternative agitating structure may have other shapes and/or include any number of trays other than the two trays of this exemplary embodiment. Such alternatives include, without limitation, an agitating structure having a single tray rather than a segmented tray assembly. Each of the individual trays of the illustrated embodiment includes several compartments 44 that hold agitating elements that move and thereby vibrate the solids deposited on the screen panel assembly 16. The agitating elements, although not shown, may for example and without limitation include balls made of metal, plastic or other suitable material and are held within the compartments 44. The agitating elements are supported by a support screen 45 and confined in the compartments 44 by partition walls 47 defining the compartments 44.

Referring to FIGS. 1 and 2, exemplary screen panels 20, 22 according to one embodiment of this invention are shown. Each screen panel 20, 22 is substantially identical to each other. The frame 26 of each screen panel includes the downwardly turned lip 46 extending longitudinally on each lateral side edge of the screen panel 20, 22. The lip 46 includes the tab 52 having a generally sloped leading edge 58 and a generally vertically oriented trailing edge 60 adjacent to the notch 50.

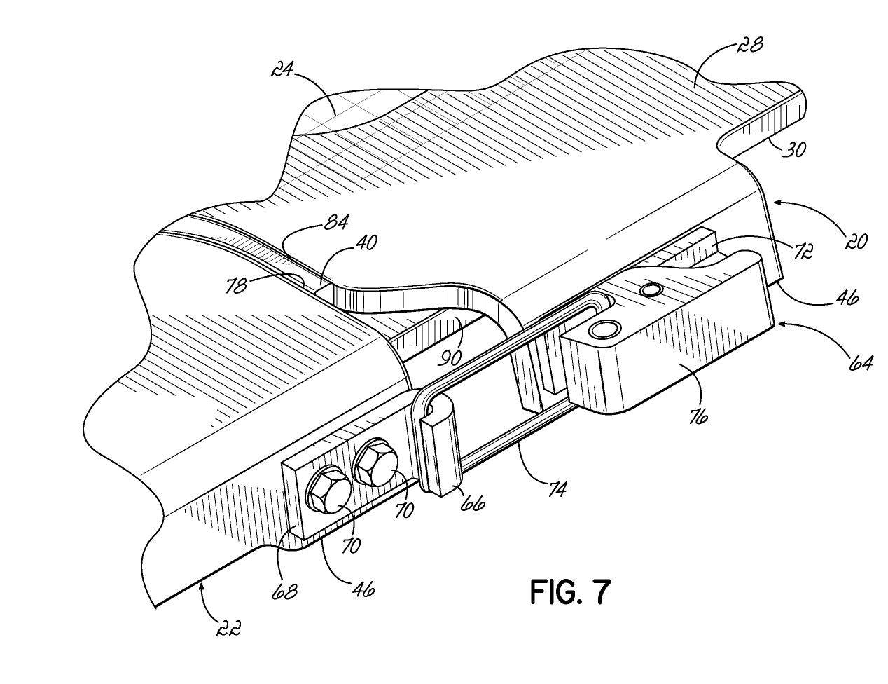

The adjacent screen panels are joined together by a coupling 62 which in one embodiment includes one or more latching mechanisms 64. One example of the latching mechanism 64 is shown particularly in FIGS. 1, 2 and 7 is an over-center draw latch. One component of the latching mechanism 64 is a receiving hook 66 on the leading end 32 of each screen panel 20, 22. The receiving hook 66 projects from a base portion 68 and is mounted to the lip 46 via mechanical fasteners 70, two of which are shown in FIGS. 1, 2 and 7 as bolts, although other mounting mechanisms may be utilized. The base portion 68 is mounted via the bolts 70 to the lip 46 so that the hook 66 is juxtaposed to the adjacent, leading screen panel 20. On the adjacent screen panel, a latch base 72 of the latching mechanism 64 is likewise mounted via a pair of mechanical fasteners 70 such as bolts to the downwardly turned lip 46. A generally rectangular-shaped member bail member 74 is pivotally coupled to a latch body 76 which is similarly pivotally coupled to the latch base 72 as is well known according to standard over-center draw latch design. Two latching mechanisms 64 are provided for each pair of adjacent screen panels 20, 22, one on each opposite lateral side edge according to one embodiment of this invention. The latching mechanisms 64 draw the confronting adjacent longitudinal ends 32, 34 of the screen panels 20, 22 together.

As shown in FIGS. 1-7, the leading longitudinal end 32 of each screen panel 20, 22 includes a contoured edge 78 with a generally linear central portion 80 bounded on each end by shoulder portions 82. The contoured leading edge 78 of each screen panel 20, 22 is shaped and configured to mate with a contoured trailing edge 84 of each screen panel which includes a generally linear central portion 86 bounded on each end by jog portions 88. Each jog 88 is configured to mate with the adjacent shoulder 82 of the adjacent screen panel. The leading and trailing contoured edges 78, 84 of the screen panels 20, 22 are positioned proximate the top face 28 of each screen panel. However, while the contoured leading edge 78 of each screen panel 20, 22 is at a distal end of the respective screen panel, the contoured trailing edge 84 of each screen panel is recessed relative to the distal edge of the screen panel such that a ledge 90 projects forwardly at a recessed level relative to the top face 28 along a substantial portion of the trailing end 34 of the screen panel 20, 22.

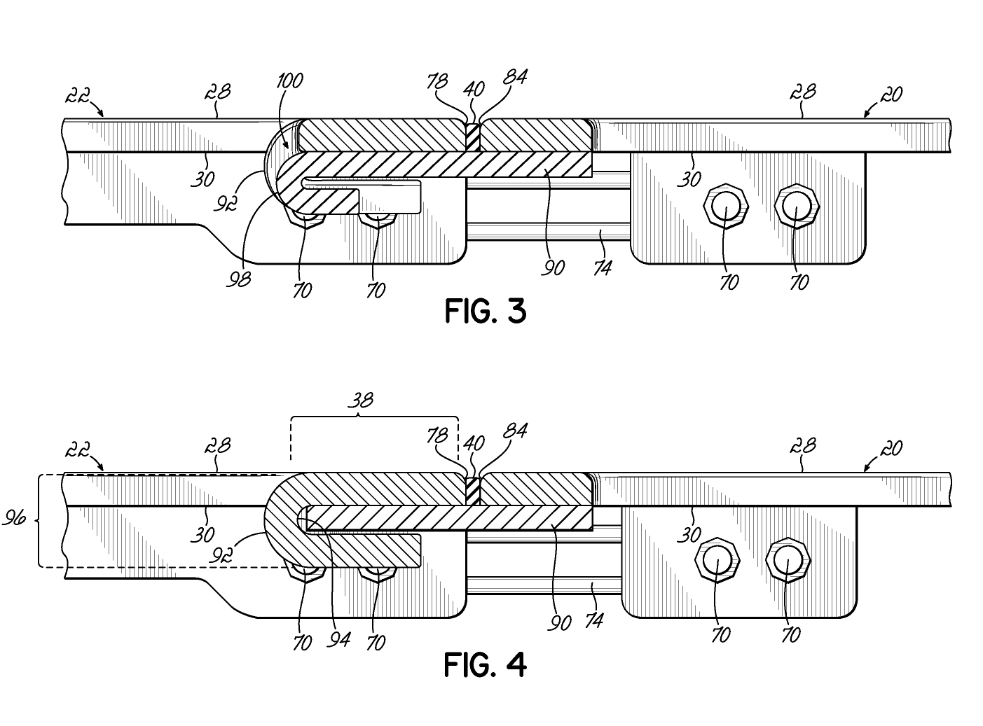

The frame 26 of each screen panel 20, 22 along the leading end 32 thereof includes a hem 92 offset or recessed from the distal edge of the screen panel. The hem 92 includes a jaw 94 which presents an opening facing the leading edge 32 of the screen panel 20, 22. The jaw 94 is sized and configured to receive therein the ledge 90 along the trailing end 32 of the leading screen panel 20 so as to provide one aspect of the coupling 62 between the adjacent screen panels 20, 22. The ledge 90 mating with the hem 92 and jaw 94 of the leading screen panel 20 provides an overlap portion 96 between the adjacent screen panels 20, 22 as shown particularly in FIGS. 3 and 4. The cross-sectional view of FIG. 4 shows the ledge 90 seated within the jaw 94 of the trailing screen panel 22. The seal member 40 is mounted along the contoured edge 84 of the trailing end 32 of the screen panel 20 atop the ledge 90. When the adjacent screen panels 20, 22 are joined together, the seal member 40 is compressed between the contoured edges 78, 84 as shown in FIGS. 3 and 4.

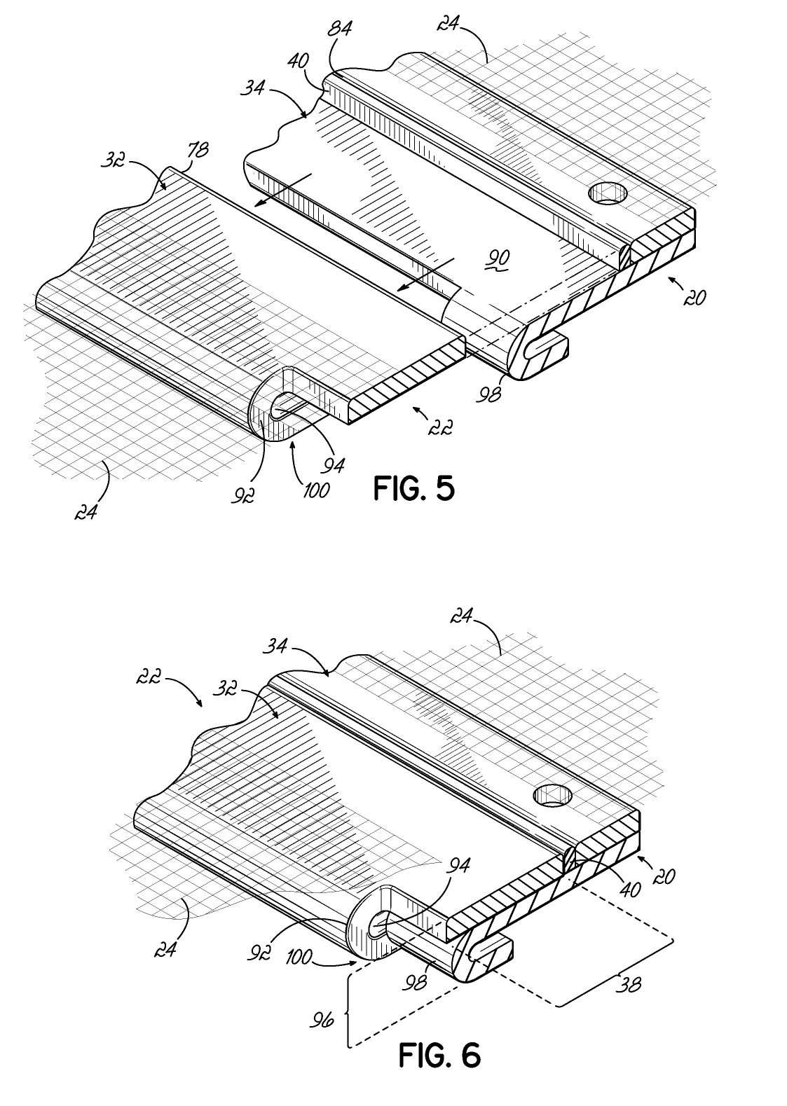

Another aspect of the coupling 62 between the adjacent screen panels 20, 22 according to various embodiments of this invention are lugs 98 which extend from the ledge 90 along the trailing end 34 of the screen panel 20. Two such lugs 98 are shown in the drawings. In particular, in FIGS. 5 and 6, one of the lugs 98 is shown as a folded under extension from the ledge 90. Each lug 98 is seated within a seat 100 formed in a gap of the hem 92 of the leading edge 32 of the trailing screen panel 22. The seats 100 are particularly shown in FIGS. 1 and 2 and are spaced across the width of the screen panel. The lug 98 positioned within the seat 100 is likewise shown in cross-sectional view of FIG. 3. The combination of the lugs 98 and the seats 100 on the adjacent mating ends 32, 34 of the screen panels 20, 22 helps to center the screen panels in a lateral direction relative to one another as well as providing an additional mechanism for coupling the panels.

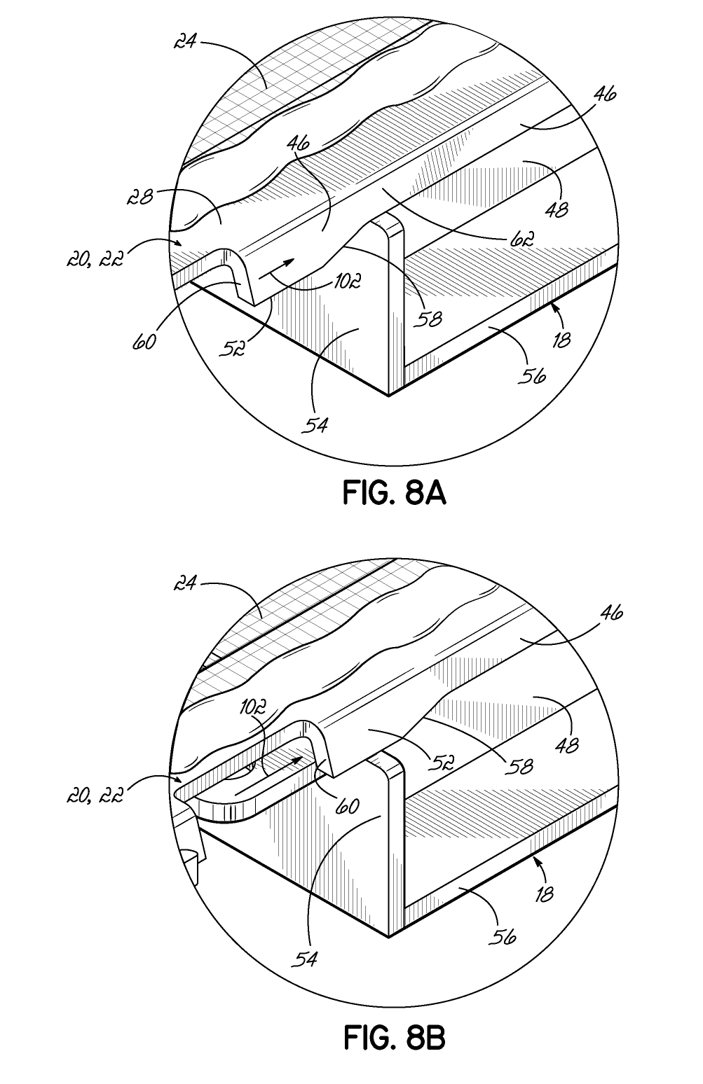

With reference to FIGS. 8A and 8B, the functionality of the limiting tabs 52 is described in further detail. FIGS. 8A-8B show an exemplary motion of the screen panel assembly 16 relative to the agitating trays 42. As the screen panel assembly 16 is pushed in the general direction of arrow 102, the screen panel assembly 16 is moved upward relative to the underlying agitating structure 18. This motion of the screen panel assembly 16 is such that the lip 46 of the screen panel 20, 22 rides over the flange 54 of the agitating structure 18. Further motion of the screen panel assembly 16 requires lifting of the leading screen panel 20 in the general direction of arrow 102 (FIG. 8A) as the leading sloped edge 58 rides over the flange 54 results in the flange 54 seating in the notch 50. Notably, the restriction of the removing motion of the first screen panel 40 provided by the engagement of the trailing edge of the limiting tab 66 with the flange. A natural stopping point at which the operator is signaled to disengage the first screen panel 40 from the second screen panel 42 is indicated as the flange enters the notch and the screen panel dips downwardly onto the tray.

Removing motion of the screen panel assembly 20 is accomplished in removing motion opposite from arrow 102, moving away from the main housing 12 and along with the agitating structure 16. Movement of the screen panel with the pulling force exerted on the screen panel opposite from arrow 102 engages the trailing edge 60 of the tab 52 with the flange 54. As the screen panel is pulled in this direction, the tab 52 results in pulling (i.e., removing motion) of the agitating structure 18 from the housing.

In operation, when engagement of the limiting tab 66 with the flange of the agitating structure 30 occurs, the first screen panel 40 is disengaged from the second screen panel 42. More specifically, the first screen panel 40 is first moved toward the main housing 14 (FIGS. 1-2) in the general direction of arrow 122 until the tab 112 engages the flange. The operator then proceeds to tilt the first screen panel 40 relative to the second screen panel 42, and then to remove the first screen panel 40 away from the second screen panel 42 in the general direction of arrow 70.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

What is claimed is:

1. A screen panel assembly for use with a screening machine, comprising:
first and second generally planar screen panels; and
a coupling between the screen panels including a projection from the first screen panel and a receiving jaw on the second screen panel configured to receive the projection.

2. The screen panel assembly of claim 1, wherein the coupling further comprises:
at least one latch mechanism releasably joining the first and second screen panels together.

3. The screen panel assembly of claim 2, wherein the mating projection and jaw are positioned along respective longitudinal ends of the screen panels and the latch mechanism is positioned at corresponding lateral side edges of the adjacent screen panels.

4. The screen panel assembly of claim 1, wherein the coupling includes an overlap region between the first and second screen panels engageable to thereby permit lifting of the second screen panel by a lifting force exerted upon the first screen panel.

5. The screen panel assembly of claim 1 further comprising:
a seal member disposed between the first and second screen panels.

6. The screen panel assembly of claim 5 wherein the seal member is positioned on a top face of one of the first and second screen panels.

7. The screen panel assembly of claim 1 wherein the projection is along a terminal longitudinal edge of the first screen panel and is recessed relative to a top face of the first screen panel.

8. The screen panel assembly of claim 1 wherein the jaw is recessed relative to a top face of the second screen panel and relative to a terminal longitudinal edge of the second screen panel.

9. The screen panel assembly of claim 1, wherein the first and second screen panels each further comprise pre-tensioned screens.

10. The screen panel assembly of claim 1 further comprising:
at least one lug projecting from one of the first and second screen panels; and
at least one seat receiving the lug when the screen panels are joined together.

11. The screen panel assembly of claim 1 further comprising:
a first contoured edge on the first panel; and
a second contoured edge on the second panel configured to mate with the first contoured edge when the screen panels are joined together.

12. The screen panel assembly of claim 11 wherein the first contoured edge is recessed from a terminal longitudinal edge of the first screen panel and proximate a top face of the first screen panel and the second contoured edge is along a terminal longitudinal edge of the second screen panel and proximate a top face of the second screen panel.

13. The screen panel assembly of claim 1 further comprising:
an agitating structure underlying the first and second screen panels;
a plurality of agitating member captured between the agitating structure and the screen panels;
a flange on the agitating structure; and
a tab on at least one of the screen panels adapted to releasably engage the flange when the agitating structure underlies the screen panel so that movement of the screen panels into and out of the screening machine induces similar movement of the agitating structure.

14. The screen panel assembly of claim 1 wherein the first and second screen panels are substantially identical and interchangeable with one another.

15. A screen panel assembly for use with a screening machine, comprising:
first and second generally planar screen panels; and
a coupling between the screen panels including at least one latch mechanism releasably joining the first and second screen panels together.

16. The screen panel assembly of claim 15, wherein the latch mechanism is positioned at corresponding lateral side edges of the adjacent screen panels.

17. The screen panel assembly of claim 16 further comprising a pair of the latch mechanisms.

18. A screen panel assembly for use with a screening machine, comprising:
first and second generally planar screen panels each having pre-tensioned screens;
a coupling between the screen panels including
(a) a projection from the first screen panel, wherein the projection is along a terminal longitudinal edge of the first screen panel and is recessed relative to a top face of the first screen panel;
(b) a receiving jaw on the second screen panel configured to receive the projection, wherein the jaw is recessed relative to a top face of the second screen panel and relative to a terminal longitudinal edge of the second screen panel;
(c) an overlap region between the first and second screen panels engageable to thereby permit lifting of the second screen panel by a lifting force exerted upon the first screen panel; and
(d) a pair of latch mechanisms releasably joining the first and second screen panels together, wherein the mating projection and jaw are positioned along respective longitudinal ends of the screen panels and each latch mechanism is positioned at a corresponding lateral side edge of the adjacent screen panels;
a seal member disposed between the first and second screen panels and positioned on a top face of one of the first and second screen panels;
at least one lug projecting from one of the first and second screen panels;
at least one seat receiving the lug when the screen panels are joined together;
a first contoured edge on the first panel, wherein the first contoured edge is recessed from a terminal longitudinal edge of the first screen panel and proximate a top face of the first screen panel; and
a second contoured edge on the second panel configured to mate with the first contoured edge when the screen panels are joined together, wherein and the second contoured edge is along a terminal longitudinal edge of the second screen panel and proximate a top face of the second screen panel;
wherein the first and second screen panels are substantially identical and interchangeable with one another.

19. The screen panel assembly of claim 18 further comprising:
an agitating structure underlying the first and second screen panels;
a plurality of agitating member captured between the agitating structure and the screen panels;
a flange on the agitating structure; and
a tab on at least one of the screen panels adapted to releasably engage the flange when the agitating structure underlies the screen panel so that movement of the screen panels into and out of the screening machine induces similar movement of the agitating structure.

20. A screening machine comprising:
a main housing;
a screen panel assembly having first and second generally planar screen panels and a coupling between the screen panels configured to permit movement of the first and second screen panels by a force exerted upon the first screen panel,
a coupling between the screen panels including
(a) a projection from the first screen panel;
(b) a receiving jaw on the second screen panel configured to receive the projection;
(c) at least one latch mechanism releasably joining the first and second screen panels together, wherein the mating projection and jaw are positioned along respective longitudinal ends of the screen panels and the latch mechanism is positioned at corresponding lateral side edges of the adjacent screen panels;
(d) an overlap region between the first and second screen panels engageable to thereby permit lifting of the second screen panel by a lifting force exerted upon the first screen panel; and
a seal member disposed between the first and second screen panels.
